(19) United States
(12) Patent Application Publication
(10) Pub. No.: US 2003/0173781 A1
(43) Pub. Date: Sep. 18, 2003

(54) Adaptor for receiving a fluidic device

(76) Inventors: John Robert Dodgson, Croydon (GB); John Edward Andrew Shaw, West Drayton (GB); Anthony Robert Corless, Ash (GB); Christopher Mathew Turner, Uxbridge (GB)

Correspondence Address: Martin Fleit, Fleit Kain Gibbons Gutman & Bongini, Suite 404, 601 Brickell Key Drive, Miami, FL, 33131, US

(21) Appl. No.: 10/276,053

(22) PCT Filed: May 14, 2001
(86) PCT No.: PCT/GB01/02090

(30) Foreign Application Priority Data
May 12, 2000 (GB) 0011575.8

(51) Int. Cl. F16L 21/00

(52) U.S. Cl. 285/397

(57) ABSTRACT

An adaptor for receiving a fluidic device (12) and facilitating connection of the device (12) to a similar device or other object, the device having defined therein at least one fluid pathway (24), the adaptor being capable of receiving fluid from said at least one pathway (24) and having connecting means (28) for connecting to the, or each fluid pathway (24), so as to substantially immobilise the pathway(s) with respect to the device, thereby preventing damage to the pathway(s), the means for connecting each pathway provides a fluid tight seal, so that in use fluid passes to/from the device, without leakage, to a similar device.

### TECHNICAL FIELD

The present invention relates to an adaptor for receiving a fluidic device.

### BACKGROUND ART

Micro-fluidic devices are commonly fabricated with channel dimensions of the order of microns or tens of microns, and the size of the device is such that making a connection between the device and external fluidic circuitry is potentially problematic. In the prior art several ways of addressing this problem have been described.

Packard et al (U.S. Pat. No. 5,640,995) disclose the concept of a modular micro-fluidic system in which micro-fluidic devices are mounted on a carrier module, which in turn can be mounted on a substrate structure which contains fluidic passages for connection to and between the carrier modules, and hence between the micro-fluidic devices. However, the main thrust of the patent is to cover the precise design of the system in which the micro-fluidic devices are used, and no details are given of how the micro-fluidic devices are to be mounted on, and sealed to, the carrier modules.

Kovacs (U.S. Pat. No. 5,890,745) describes a method of connection of a capillary to a micro-fluidic chip, in which a capillary is inserted into a channel of diameter controlled to be very close to that of the capillary, sealing being achieved either by close fit alone, by a compressive plastic component mounted on the chip, or by contraction of the capillary at low temperature before insertion into the channel. In a preferred embodiment, adhesive is used to hold the capillary in place, and by implication acts as the main sealing method. However, no means are provided to control the flow of this sealant and so this method is likely to depend critically on maintaining close tolerance between the capillary and the channel. Also, the method will be awkward to implement for multi-way connections.

Gonzalez et al (in “Fluidic Interconnects for Modular Assembly of Chemical Microsystems,” in Proceedings of 1997 International Conference on Solid-State Sensors and Actuators, Chicago, Institute of Electrical and Electronics Engineers, pp 527-530, 1997) describe an interconnect fabricated by micro-machining silicon and glass to produce an interlocking structure, final fluid sealing being achieved by a silicone rubber gasket patterned around the fluid conduit faces. This structure aims to begin a connection onto a Si/glass micro-fluidic wafer device, but is highly complex, and due to the fragile nature of the micro-machined projections, unlikely to be robust in manufacture or use.

An alternative approach has been described by VerLee et al., (VerLee D, Alcock A, Clark G, et al., “Fluid Circuit Technology: Integrated Interconnect Technology for Miniature Fluidic Devices,” in Proceedings of Solid State Sensor and Actuator Workshop, Hilton Head Island, S.C., pp 9-14, 1996), where they describe the concept of a hybrid micro-fluidic structure comprising micro-fluidic MEMS (Mlicro Electro Mechanical System) devices bonded to a plastic fluidic circuit, which acts either in the manner of a ‘chip carrier’ in connecting the device to an external fluidic circuit, or as an analogue to a printed circuit board in electronic circuitry. Few details are given about how such a design might be implemented (see p. 14), but mention is made of the use of acrylic to bond the MEMS to the plastic.

This last approach has the advantage that delicate micro-fluidic interconnection components are avoided and the system is suitable for multiple connections to be made simultaneously in a simple assembly process. The present invention aims to provide simple and effective means for achieving these aims.

### DISCLOSURE OF INVENTION

According to a first aspect of the invention there is provided an adaptor as claimed in claims 1 to 15.

According to a second aspect of the invention there is provided a method of coupling a micro-fluidic device to a further device using the adaptor claimed in any of claims 1 to 15.

The invention comprises a number of ways of achieving the aim of coupling a microfluidic device to a plastic substrate. Some of these involve the use of capillary connections to the edge of the device as covered in our pending patent application no. GB 9625491.7. Wherever seals of capillaries into channels are referred to, unless stated otherwise, it is intended that sealing methods as described in the applicants' co-pending application, are to be used. Other included concepts involve extensions to the idea of VerLee et al above, with devices sealed on a planar face to the substrate.

### BRIEF DESCRIPTION OF DRAWINGS

A number of embodiments of the invention will now be described with reference to the Figures, where:

FIG. 1a shows a cross-sectional view of a micro-fluidic assembly;

FIG. 1b shows a plan view of the micro-fluidic assembly of FIG. 1a;

FIG. 1c shows a cross-sectional view of part of a micro-fluidic assembly;

FIG. 2 shows a plan view of another micro-fluidic assembly;

FIG. 3 shows a cross-sectional view of part of a further micro-fluidic assembly;

FIG. 4a shows a cross-sectional view of another micro-fluidic assembly;

FIG. 4b shows a plan view of the micro-fluidic assembly of FIG. 4a;

FIG. 5a shows a plan view of a further micro-fluidic assembly;

FIG. 5b shows a cross-sectional view of the micro-fluidic assembly of FIG. 5a;

FIG. 6 shows a cross-sectional view of a further micro-fluidic assembly;

FIG. 7 shows a cross-sectional view of part of another micro-fluidic assembly;

FIG. 8 shows a cross-sectional view of part of another micro-fluidic assembly; and

FIG. 9 shows a cross-sectional view of part of another micro-fluidic assembly.

### DETAILED DESCRIPTION OF PREFERRED EMBODIMENTS

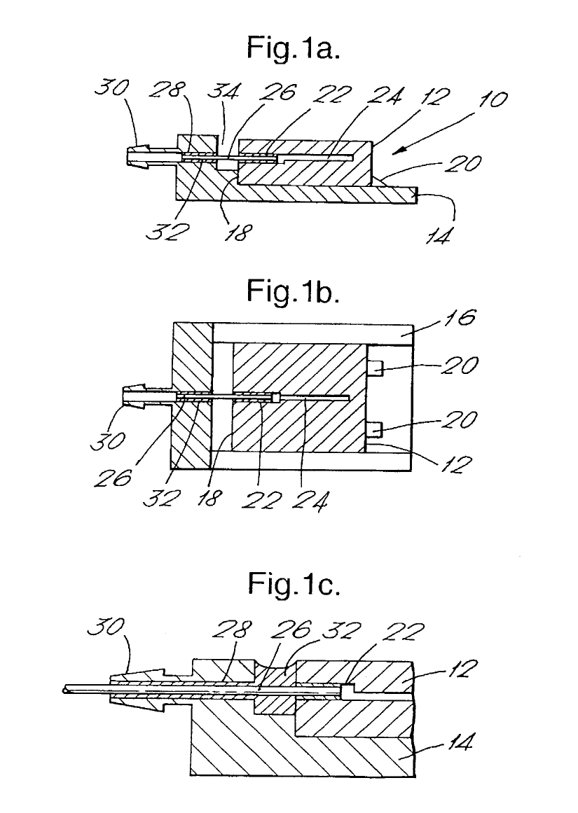

FIG. 1a and FIG. 1b show a micro-fluidic assembly (10) comprising a micro-fluidic device (12) mounted on a carrier substrate (14). The micro-fluidic device (12) has a rectangular cross-section, with the upper and lower faces being longer than the side faces. The micro-fluidic device has an inlet port (22) formed in a side face, and connects to a channel (24) which lies parallel to the upper and lower faces. The device (12) is supported on the substrate by raised features (16) and (18) formed on the substrate, and is retained in place by a clip (20). The carrier substrate (14) has a channel (28) formed therein.

In the embodiment shown in FIG. 1, the device (12) is intended to slide into the substrate (14). Vertical restraint of the device (12) might be provided by a lip (not shown) on raised sides (16). Alternatively, the features on the carrier that serve to locate the device might be for alignment purposes only, fixture of the device to the carrier being by other means, for example adhesive.

Inlet port (22) has a capillary (26) sealed therein for example in the manner as described patent application no. GB 9625491.7. The capillary (26) is inserted into the channel (28) in the carrier substrate, and sealed with a sealant (32) in a similar manner, or in the manner of the applicants' co-pending patent application no. GB 0011428.0 of even date entitled ‘method of forming a fluid tight seal’. The design of the device (12) and the carrier substrate is such that once the capillary (26) has been sealed into the inlet port (22) in the device, the device plus capillary can be inserted into the carrier, the capillary being automatically aligned such that it fits simultaneously and without additional operator interference into the corresponding channel (28). To this end, the carrier is designed to suit the device such that the vertical and horizontal alignment of the capillary and channel is ensured.

The carrier substrate channel (28) is connected to external fluidic circuits by means of a connector (30) formed as part of the carrier. Barbed connectors (30) are shown in FIG. 1, but any practical connection might be included as part of the carrier. The carrier substrate in FIG. 1 is shown as holding only one micro-fluidic device (12) but it is intended that more than one might be accommodated on each carrier substrate. The carriers can also be attached by either a plug arrangement or by a permanent seal to further fluidic circuitry in a further substrate.

In a preferred embodiment of the device shown in FIG. 1c, the capillary (26) is long enough to reach from the device (12), right through the connector (30), extending beyond it. The device (12) and capillary (26) are then sealed in place, the sealant reaching to the end of the connector (30), and after that the capillary is trimmed to length. This method of assembly has the advantage that dead volumes inside the channel (28) is avoided, and so is the possibility of blockage of the end of the capillary during the process of applying the sealant (32).

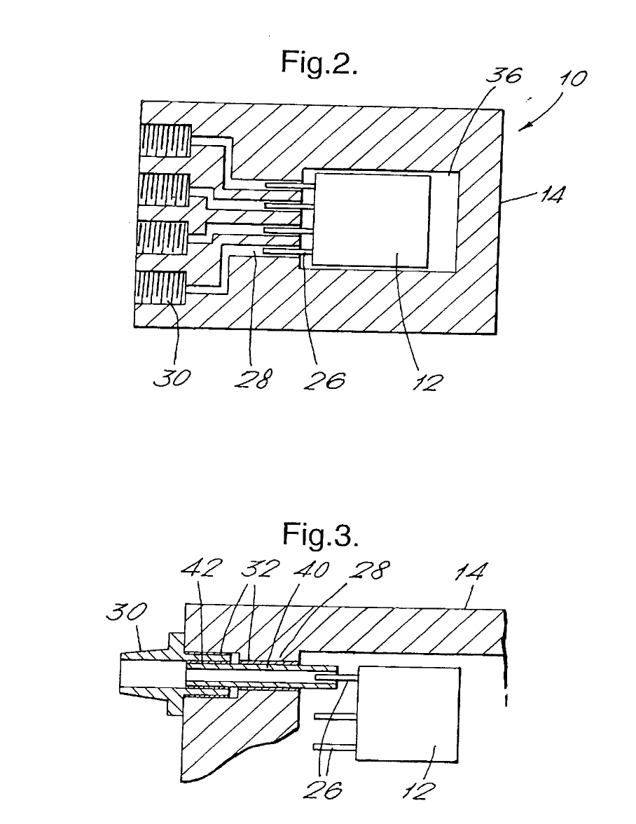

FIG. 2 shows an alternative embodiment, in cross section through the level of the capillary connections (26) and channels (28) in the carrier substrate (14), in which the carrier (14) has a recess (36) into which the device (12) fits. The capillary connections (26) slide into the channels (28) as the device is seated in its final position in the recess (36). The device (12) is then sealed in position, and the capillaries (26) sealed into the channels in the manner referred to above. In FIG. 2, the fluidic connections (30) to the carrier substrate are shown as a screw-fit, for example standard ¼-28, female connection. As a variation on this design, the capillaries (which are flexible to a degree) might be led by gently curving channels from the device (12) to the connectors (30), the sealing being done as described in FIG. 1c.

FIG. 3 shows a further embodiment in which a second capillary (40) is used to complete the fluidic connection from the device (12) to the connector (30) through the carrier substrate (14). This allows the seal to the capillary (26) which is associated with the device to be made very precisely, and avoids contact of the fluid with the material of the carrier, potentially an advantage in the case of aggressive fluids such as solvents and solutions at extremes of pH. Capillary (26) is associated with the device (12) as before and fitted to it before the device is mounted in the carrier substrate (14). Capillary (40) is sealed in advance to the connector (30) at surface (42). The device (12) is inserted into the carrier substrate (14), and the connector (30) and associated capillary (40) mounted into the carrier, such that capillary (26) enters the end of capillary (40). The capillaries are then sealed and the connector and capillary (40) sealed to the carrier substrate (14). The precise order of the sealing operations can be varied for convenience.

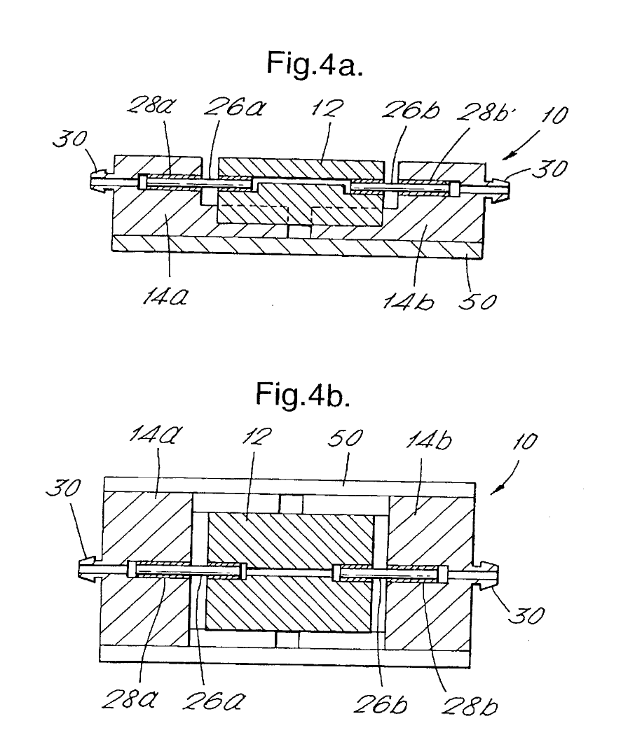

FIG. 4 shows a further embodiment in which capillary connections are used to join a micro-fluidic device (12) to a carrier substrate (14). It will be apparent that the embodiments in FIGS. 1 and 2 are only usable when capillary connections are made to one edge of the device (12) only. In the case that more than one side has connections, then allowance must be made for movement of the connecting channels on all but one, or all, sides of the device. FIG. 4a shows a cross-section and FIG. 4b a plan view cross-section of an assembly designed for a device (12) with capillary connections on two edges. One connection is shown on each edge for clarity, but obviously many might be made in the same way.

Capillaries (26a) and (26b) are sealed into the micro-fluidic device (12) at each of two sides. In this case, the carrier (14) consists of two parts: a first carrier component (14a) and a second carrier component (14b). These component parts (14a, b) are moveable with respect to one another, such that the device (12) can be mounted on one or both of them. In order to form the assembly (10), the capillaries (26a) are introduced in the channels (28a) in the first carrier component (14a), and the second carrier component (14b) is moved towards the device (12) until the capillaries (26b) are introduced into the channels (28b) in the second carrier component.

The first and second carrier components (14a) and (14b) are held in a further component (50) to give rigidity to the assembly (10), and to control the way the assembly comes together in order to avoid strain on, and possible breakage of, the capillaries. Once the assembly (10) has been brought together, the device (12) and carrier components (14a, b) can be sealed together and the capillaries sealed into the channels. Although connections to two sides of the device (12) are shown, it is understood that connections to more sides might be made by including more carrier (14) components.

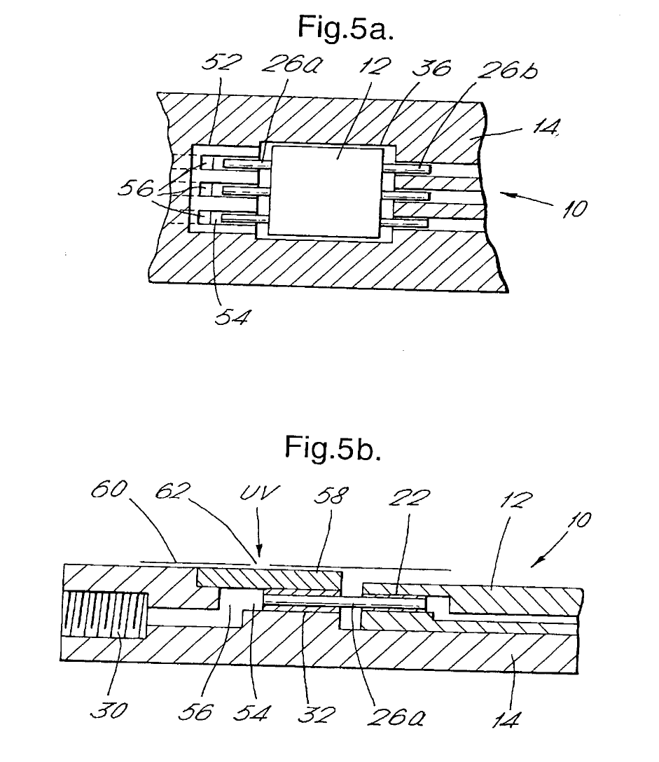

FIG. 5 shows an alternative embodiment of the invention in which connection can be made to capillaries at more than one edge of a device (12) while using a carrier (14) with a main single part and a number of small additional parts. Instead of the sliding fit of capillaries (26) into the channels (28) as in the previous embodiments, in certain cases (especially with a larger number of capillaries per side of the device) it will be easier to lay the capillaries in an open channel (54), then cover the channel with a further component to form a closed connection channel suitable for sealing.

FIG. 5a is a partial plan view and FIG. 5b is a partial cross-section through the assembly (10) at the centre of one of the capillary connections (26). It is understood that the complete assembly (10) in this embodiment will resemble that in FIG. 2 (except that the device (12) may have connections at more than one side) and that FIG. 5 is intended to show the main features of this embodiment of the invention in more detail.

A micro-fluidic device (12) fits into a recess (36) formed in the carrier (14). The recess (36) contains locating features (not shown) to align the capillary connections (26a, b) associated with the device (12) in open topped channels or slots (54) which communicate with the recess (36) at a level above the floor of the recess such that the capillaries (26a, b) lie straight between the device and the slots. The slots (54) are located in the base of a second shallower recess (52) communicating with the recess (36), the recess (52) being closeable by a lid (58). Slots (54) act as fluid communication channels when closed and communicate with ports (56), which in turn lead to channels inside the body of the carrier (14) and thence to connections (30).

The lid (58) is sealed in place to the bottom of the shallow recess (52) by means of adhesive placed on either component. This isolates the slots (54) one from another. The device capillaries (26a) are then sealed into the channels so formed by one of the methods described above. An example method is shown in FIG. 5b. In this case, the lid (58) is UV transparent, and UV curing adhesive is used for the seal. A mask (60) with an aperture (62) is placed over the seal area such that the aperture is located where the furthest extent of the seal is intended to be (i.e. just short of the ports (56)). UV cure adhesive (32) is wicked into the seal space and the UV illumination turned on, so as to harden the adhesive when it wicks as far as the aperture. This prevents the adhesive over-running and filling the ports (56). The mask is then removed and the whole area of adhesive illuminated to harden it completely.

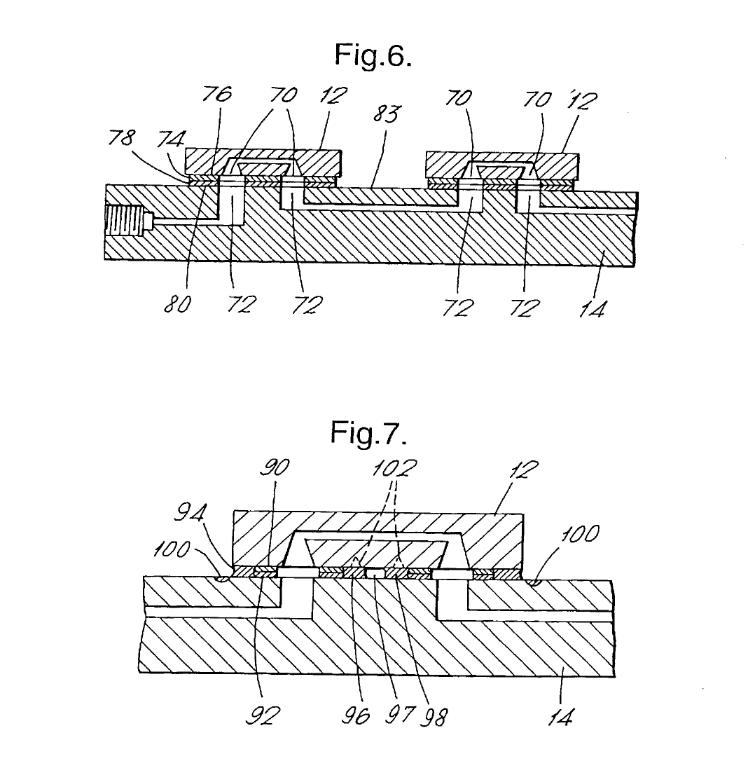

FIG. 6 shows a partial cross section through a further alternative embodiment in which capillary connections are not used, but instead the assembly consists of one or more devices (12) mounted on a carrier or substrate 14, such that a seal is made between a face of the device and a plane surface of the carrier. The devices have fluidic ports (70) in their surface (76), and the carrier has fluidic ports (72) in its top surface (80), the two sets of ports being arranged to align. The devices and the substrates are shown having a single channel between the ports and external connectors but obviously these could be fluidic circuits of arbitrary complexity. VerLee et al (see above) imply that a seal might be made between the device and the substrate in such a geometry by means of an acrylic/silicon bond, but no details were given. Therefore, if the device (12) was placed on an acrylic substrate (14) and the two heated under slight pressure, they should bond. However, there is the danger of deformation of the substrate around the seal area if the temperature is held at that approaching the softening point of the substrate and so this simple approach has disadvantages—if it can be made to work, then the pressure must be very slight, the temperature as low as possible, and therefore the time to achieve the bond will be long.

A better arrangement involves a specific area of seal material (74) applied to the device before the bonding process, this then being sealed either directly to a compatible substrate or to another layer of seal material (78), previously applied to the substrate. This will allow greater pressure and higher temperature to be used, so speeding the process. A suitable material (74) would be a photopatternable acrylic such as is used for electron beam patterning resist in e-beam lithography. This can be deposited and patterned (if necessary) over the seal surface (76) of the devices, which could then be sealed directly to an acrylic substrate. The second layer (78) of seal material might also be acrylic, on a substrate of higher softening point such as polycarbonate. Heat might be delivered by uniform heating of the assembly under pressure, or by delivering heat specifically to the seal area, for example by arranging that the seal materials, a filler within them, or a layer included in the structure next to them be efficient absorbers of radiation, for example visible laser light, IR, microwave or RF.

A further embodiment also described by FIG. 6 uses a different seal method. Two part adhesive is used, in which (74) is the adhesive and (78) the hardener, or vice versa. Therefore a bond is only formed where the two parts are brought together. Any residual material in the port area can then be washed out with solvent following curing of the adhesive. For example, petroleum ether can be used to remove the components of a two-part epoxy adhesive. Alternatively, the residual material in the ports and/or channels might be cured in situ after bonding by applying the other component, for instance by flowing it (if necessary in a suitable solvent) through the device.

FIG. 7 shows a partial cross section through a further embodiment in which the means for sealing the fluidic connection and the means for retaining the device in place on the substrate are separate. This has the advantage that the seal material can be made robust to a wide range of chemicals and is useful particularly for liquid connections. The device (12) and the substrate (14) have around the corresponding ports a patterned area (90, 92) respectively of seal material which is not wetted by the liquid which is intended to flow through the connection, for example PTFE or other fluoropolymer patterned around the hole, such as by sputtering plus a photomask process. The seal areas are not adherent to one another, and have minimal compliance, but the liquid will not enter any minute capillary space left between them when the device is fixed in place. The fixing is achieved by for example a fillet of adhesive (94) applied outside the seal areas. The adhesive wets the device and the substrate, but preferably does not wet the seal material (90, 92) either, so does not tend to enter any space between them. The adhesive will tend naturally to fill the capillary space between the device and the substrate. This can be assisted, and the way that the adhesive flows be guided so as to avoid voids (e.g. as shown as (97) between adhesive areas (96) and (98)), by capillary channels which will act as leads to the flow, such as shown at (100) (which will also serve to define the position of adhesive on the surface of the substrate and as a positioning guide for the device) and (102). The shape of the guides will depend on the fabrication method, but might for example be semicircular in cross section in an embossed plastic substrate, or triangular in an etched Si surface.

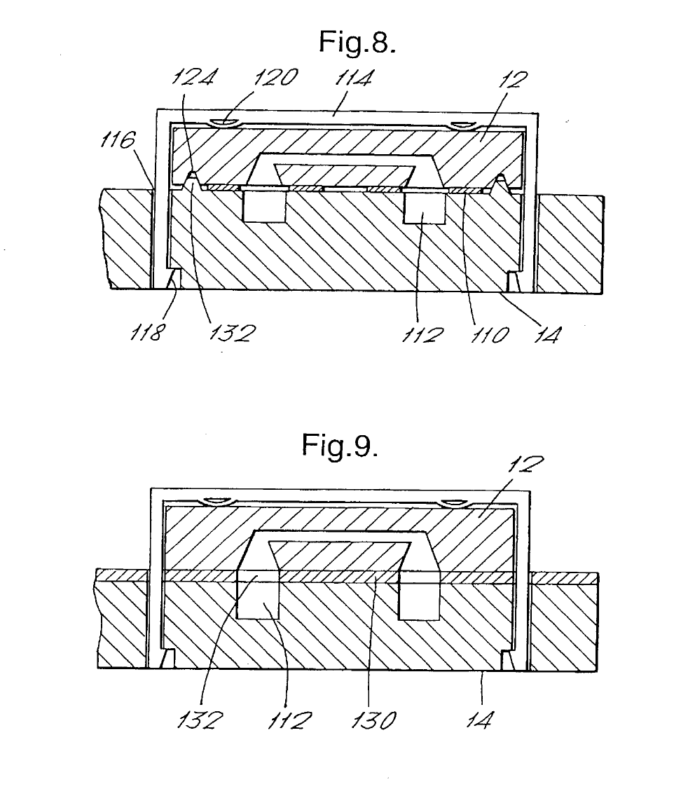

FIG. 8 shows a partial cross section through a further embodiment in which a device (12) is mounted on a substrate (14) by means of a compliant seal (110). The channels (112) in the substrate are shown to run perpendicular to the cross section for clarity. The seal (110) is formed by for example patternable silicone rubber, deposited on the device surface by a photomasking technique. The silicone rubber is preferably patterned to form seal surfaces around the ports, in order to maximise the probability of a good seal, but optionally might cover the entire device surface if it is sufficiently compliant. The device is held in place by one of a number of techniques; shown in FIG. 9, a clip (114) is located by means of holes (116) in the substrate and sprung catches (118) which engage a lip in the holes. Deformable features (120) might be provided to control the amount of pressure applied to the chip. Alternative methods of attaching the chip, such as heat staking, ultrasonic bonding, curing adhesive while the seal is under pressure, etc., might be applied. If the clip (114) or other chosen attachment method is designed to be reversible, a make and break connection might be achieved. Location of the device relative to the substrate might be achieved by the design of the clip and the positioning of the holes. Alternatively location lugs (122) and mating recesses (124) might be included.

FIG. 9 shows a partial cross section through a further embodiment similar to that in FIG. 9 except that here the seal surface (130) is included over a continuous area of the surface of the substrate (14), either over the whole microfluidic area of the substrate, or preferable as an insert in the region in which the device is to be mounted. Seal material (130) is preferably silicone rubber but any other compliant material compatible with the fluids of interest can be used. Ports (132) in the seal material leading to channels (112) in the substrate can be formed by moulding around a master, or by photopatterning, and the seal material can be in a thin sheet form suitable for laying over the surface of the substrate, or might be a thicker component inset into a recess in the substrate. Optionally, the seal component might have channels contained within its thickness that do not extend to the substrate.

1. An adaptor for receiving a fluidic device (12) and facilitating connection of the device (12) to a similar device or other object, the device having defined therein at least one fluid pathway (24), the adaptor being capable of receiving fluid from said at least one pathway (24) and having connecting means (28) for connecting to the, or each fluid pathway (24), so as to substantially immobilise the pathway(s) with respect to the device, thereby preventing damage to the pathway(s), the means for connecting each pathway provides a fluid tight seal, so that in use fluid passes to/from the device, without leakage, to a similar device.

2. An adaptor according to claim 1 wherein a capillary tube (26) is disposed within, and extends from, each fluid pathway (24).

3. An adaptor according to claim 1 further including retaining means for retaining the fluidic device in place.

4. An adaptor according to claim 3 wherein the retaining means comprises a recess (36).

5. An adaptor according to claim 4 wherein the walls (16) of the recess (36) include a lip so as to retain the device.

6. An adaptor according to claim 3 wherein the retaining means includes a clip (20).

7. An adaptor according to any previous claim wherein the connecting means (28) is a channel.

8. An adaptor according to any previous claim further including coupling means (30) for coupling the adaptor to a further device.

9. An adaptor according to any previous claim wherein the adaptor comprises a first component (14a) and a second component (14b).

10. An adaptor according to claim 9 wherein the first component (14a) and second component (14b) are moveable with respect to one another such that the device (12) can, in use, be mounted on one or both components.

11. An adaptor according to claim 10 wherein the first (14a) and second (14b) components are supported by a further component (50).

12. An adaptor according to claim 1 wherein the similar device or object has fluid pathways of similar packing density to the device (12).

13. An adaptor according to claim 1 wherein the similar device or object has fluid pathways of different packing density from the device (12).

14. An adaptor according to claim 2 wherein the connecting means (28) further includes a capillary connection (40) which, in use, is capable of receiving a capillary tube (26).

15. An adaptor according to any previous claim wherein at least a portion of the adaptor is transmissive to UV radiation.

16. A method of coupling a micro-fluidic device (12) to a further device using the adaptor (14) claimed in any of claims 1 to 15, the method comprising the steps of: providing a micro-fluidic device (12) having at least a first pathway (24) defined therein; connecting a capillary tube (26) to the at least first pathway (24); providing an adaptor (14) having means for retaining the micro-fluidic device (12), and at least one pathway (28) formed therein, and coupling means (30) for coupling the micro-fluidic device (12) to a further device; inserting a capillary tube (26) into said respective pathway(s) (28) so as to form a micro-fluidic assembly (10); and coupling the micro-fluidic assembly (10) to the further device by way of the coupling means (30).

17. A method according to claim 16 wherein the capillary tube(s) is sealed into the respective pathway (28) by used of a sealant.

18. A method according to claim 17 wherein the sealant is cured using UV radiation.

19. An adaptor substantially as described herein with reference to FIGS. 1 to 9 of the accompanying drawing.
